(19) United States
(12) Patent Application Publication
(10) Pub. No.: US 2005/0076232 A1
(43) Pub. Date: Apr. 7, 2005

(54) Client apparatus and content processing method in client apparatus, and content provision system

(75) Inventor: Takayoshi Kawaguchi, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 10/909,130

(22) Filed: Jul. 30, 2004

(30) Foreign Application Priority Data
Aug. 1, 2003 (JP) P2003-285270

(51) Int. Cl. G06F 12/14; H04L 9/00; H04L 9/32

(52) U.S. Cl. 713/200

(57) ABSTRACT

A client apparatus can protect a content key, which is required for decrypting encrypted content, from a malicious third party. In the client apparatus, an authority managing unit and a content using unit share a session key (distribution key) provided in common to all apparatuses before shipment. Therefore, when the authority managing unit sends a content key to the content using unit, the authority managing unit encrypts the content key with the session key that the authority managing unit itself has. Then, the authority managing unit sends the encrypted content key to the content using unit via a common bus. The content using unit, having received the encrypted content key, decrypts the encrypted content key with the session key, which the content using unit itself also has, to obtain the content key.

### CROSS-REFERENCE TO RELATED APPLICATIONS

The present application claims priority from Japanese Application No. 2003-285270, filed Aug. 1, 2003, the disclosure of which is hereby incorporated by reference herein.

### BACKGROUND OF THE INVENTION

The present invention relates to a client apparatus, and in particular, to a client apparatus that is connected to a network and that receives content data and key information from a server, which is also connected to the network, and to a content processing method in the client apparatus. In addition, the present invention relates to a content provision system that provides content to a client apparatus from a server connected to the client apparatus via a network.

A service for purchasing digital content such as music and videos through a network such as the Internet has become popular. For example, if electronic music distribution (EMD) using the Internet is used, it is possible to download digital music content, save the content in a personal computer serving as a client terminal, and listen to the music on a personal computer.

In this case, the personal computer starts a music recording reproduction application, which adopts a predetermined copyright protection technique, on the basis of an operating system (OS), and stores a content file, including encrypted digital content and a write file in which conditions for use corresponding to the digital content are described, in an HDD or the like to realize a secure service.

JP-A-2002-359616 filed by the applicant discloses an information processing apparatus and the like that has an object of preventing illegal use of content without preventing distribution of the content by starting a music recording reproduction application that adopts a predetermined copyright protection technology.

Incidentally, in JP-A-2002-359616, it is considered desirable that the program for causing a computer to execute processing related to security be encrypted in order to prevent the processing from being analyzed. For example, concerning a technique for encryption, a technique for providing the program as a tamper resistant module is disclosed. However, the program is weak in tamper resistance, and a program having tamper resistance has a problem in portability and performance.

Consequently, until a user extracts a content key from copyright management information and sends the content key to a decryption unit that decrypts encrypted content, the user may suffer an attack by a malicious third party (attacker), whereupon, for example, the content key may be stolen.

### SUMMARY OF THE INVENTION

The present invention has been devised in view of the actual circumstances describe above, and it is an object of the present invention to provide a client apparatus, a content processing method in the client apparatus, and a content provision system that can protect a content key, which is required for decrypting encrypted content, from a malicious third party.

In order to solve the above-mentioned problems, a client apparatus in accordance with the present invention is connectable to a network for receiving content data and key information from a server connected to the network, the client apparatus including: an interface unit operable to capture encrypted content data sent from the server via the network, and key information in which a content key used for generating the encrypted content data is encrypted and stored; a content data using unit operable to receive the encrypted content data captured by the interface unit, to decrypt the encrypted content data, and to use the content data; an authority managing unit operable to extract the content key from the key information captured by the interface unit; and a common bus operable to connect the interface unit, the content data using unit, and the authority managing unit and to transmit at least the encrypted content data and the key information, wherein the authority managing unit encrypts the content key using a distribution key to obtain a second encrypted content key and distributes the second encrypted content key to the content data using unit, and the content data using unit decrypts the second encrypted content key using the distribution key to obtain a decrypted content key, decrypts the encrypted content data using the decrypted content key, and uses the content data.

In this client apparatus, the authority managing unit encrypts a content key using a distribution key and distributes the encrypted content key to the content data using unit, and the content data using unit decrypts the encrypted content key using the distribution key and uses the decrypted content key for decrypting of encrypted content.

In order to solve the above-mentioned problems, a content processing method in accordance with the present invention is a content processing method in a client apparatus that is connectable to a network for receiving content data and key information from a server connected to the network, the content processing method including: a receiving step of receiving encrypted content data sent from the server via the network, and key information in which a content key used for generating the encrypted content data is encrypted and stored; an authority managing step of extracting the content key from the key information, and encrypting the content key using a distribution key to obtain a second encrypted content key; and a content data using step of receiving the second encrypted content key from the authority managing step, decrypting the second encrypted content key using the distribution key to obtain a decrypted content key, decrypting the encrypted content data using the decrypted content key, and using the content data.

In the content processing method, the authority managing step encrypts a content key using a distribution key and distributes the encrypted content key to the content data using step, and the content data using step decrypts the encrypted content key using the distribution key and uses the decrypted content key for decrypting of encrypted content.

In order to solve the above-mentioned problems, a content provision system in accordance with the present invention includes a client apparatus; and a server connected to the client apparatus via a network for providing content to the client apparatus, the client apparatus including: an interface unit operable to capture encrypted content data sent from the server via the network, and key information in which a content key used for generating the encrypted content data is encrypted and stored; a content data using unit operable to receive the encrypted content data captured by the interface unit, to decrypt the encrypted content data, and to use the content data; an authority managing unit operable to extract the content key from the key information captured by the interface unit; and a common bus operable to connect the interface unit, the content data using unit, and the authority managing unit, and to transmit at least the encrypted content data and the key information, wherein the authority managing unit encrypts the content key using a distribution key to obtain a second encrypted content key and distributes the second encrypted content key to the content data using unit, and the content data using unit decrypts the second encrypted content key using the distribution key to obtain a decrypted content key, decrypts the encrypted content data using the decrypted content key, and uses the content data.

In this content provision system, the authority managing unit of the client apparatus encrypts a content key using a distribution key and distributes the encrypted content key to the content data using unit, and the content data using unit decrypts the encrypted content key using the distribution key and uses the decrypted content key for decrypting of encrypted content.

According to the client apparatus of the present invention, the authority managing unit encrypts a content key using a distribution key and distributes the encrypted content key to the content data using unit, and the content data using unit decrypts the encrypted content key using the distribution key and uses the decrypted content key for decrypting of encrypted content. Thus, the client apparatus can protect the content key required for decrypting encrypted content from a malicious third party.

According to the content processing method in the client apparatus of the present invention, the authority managing step encrypts a content key using a distribution key and distributes the encrypted content key to the content data using step, and the content data using step decrypts the encrypted content key using the distribution key and uses the decrypted content key for decrypting of encrypted content. Thus, the content processing method can protect the content key required for decrypting encrypted content from a malicious third party.

According to the content provision system of the present invention, the authority managing unit of the client apparatus encrypts a content key using a distribution key and distributes the encrypted content key to the content data using unit, and the content data using unit decrypts the encrypted content key using the distribution key and uses the decrypted content key for decrypting of encrypted content. Thus, the content provision system can protect the content key required for decrypting encrypted content from a malicious third party as a system.

### BRIEF DESCRIPTION OF THE DRAWINGS

In the accompanying drawings:

FIG. 1 is a diagram of a content provision system;

FIG. 2 is a block diagram showing the structure of a main part of a client and a peripheral part thereof according to a first embodiment of the present invention;

FIG. 3 is a block diagram showing the structure of each server;

FIG. 4 is a flowchart for explaining download processing for content in a client according to a first embodiment of the present invention;

FIG. 5 is a flowchart for explaining content provision processing in a content server;

FIG. 6 is a format chart of content in the case in which content is supplied from a content server to a client;

FIG. 7 is a flowchart for explaining content reproduction processing in the client according to the first embodiment of the present invention;

FIG. 8 is a flowchart for explaining license acquisition processing in the client according to the first embodiment of the present invention;

FIG. 9 is a diagram showing the structure of a license;

FIG. 10 is a flowchart for explaining license provision processing in a license server;

FIG. 11 is a flowchart for explaining license renewal processing in the client according to the first embodiment of the present invention;

FIG. 12 is a flowchart for explaining license renewal processing in a license server;

FIG. 13 is a diagram for explaining the structure of a key;

FIG. 14 is a diagram for explaining a category node;

FIG. 15 is a diagram showing a specific example of correspondence among nodes and devices;

FIG. 16 is a diagram for explaining the structure of an enabling key block;

FIG. 17 is a diagram for explaining the use of the enabling key block;

FIG. 18 is a diagram for explaining the format of the enabling key block;

FIG. 19 is a diagram for explaining decryption processing for content using a DNK;

FIG. 20 is a diagram for explaining an example of the enabling key block;

FIG. 21 is a flowchart showing a processing procedure in the client according to the first embodiment of the present invention;

FIG. 22 is a block diagram showing the structure of a client according to a second embodiment of the present invention;

FIG. 23 is a flowchart showing a processing procedure from the time when the client according to the second embodiment of the present invention generates a session key until the time when an authority management unit extracts the session key;

FIG. 24 is a block diagram showing the structure of a client according to a third embodiment of the present invention; and

FIG. 25 is a flowchart showing a processing procedure in the client according to the third embodiment of the present invention.

### DETAILED DESCRIPTION

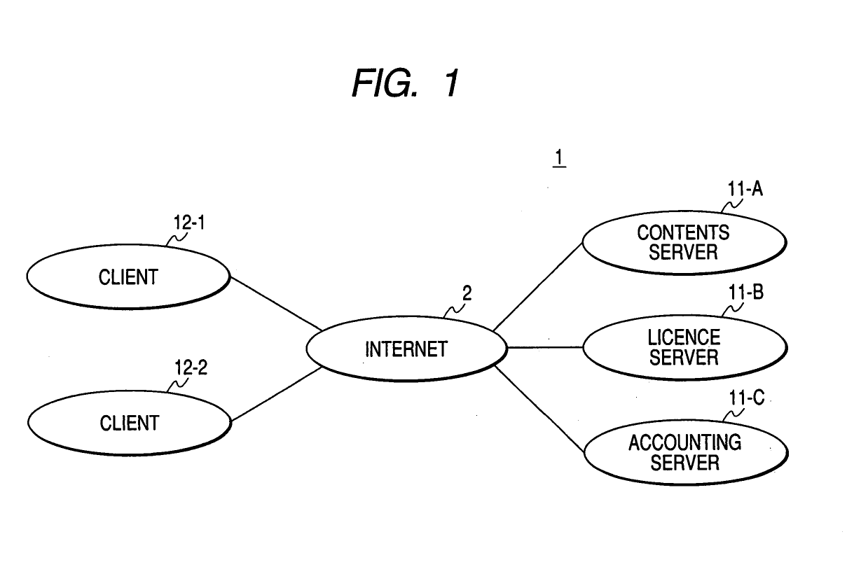

Several embodiments of the present invention will be hereinafter explained with reference to the accompanying drawings. A first embodiment relates to client apparatuses (or “clients”) 12-1 and 12-2 constituting a content provision system 1 shown in FIG. 1 (when it is unnecessary to distinguish these clients from each other, the clients will be referred to hereinafter simply as the client 12). The client 12 is connected to various servers via the Internet 2 that is a specific example of a network. It is needless to mention that an arbitrary number of clients are connected to the Internet 2.

Servers 11, which are connected to the client 12 via the Internet 2, include a content server 11-A that provides content to the client 12, a license server 11-B that grants a license necessary for using the content provided by the content server 11-A to the client 12, and an accounting server 11-C that performs accounting with respect to the client 12 when the client has received a license. The content server 11-A, license server 11-B, and accounting server 11-C are also connected to the Internet 2 in an arbitrary number.

The client 12 includes a keyboard, a mouse, or other input devices and informs the content server 11-A of content which a user desires to receive based on an operation of the user.

The content server 11-A encrypts the content identified by the client 12 using a content key Kc and generates encrypted content Kc (content). In addition, in the content server 11-A, the content key Kc itself is encrypted using, for example, a key peculiar to a client apparatus which can be used in the client apparatus and which is added to a header of the encrypted content Kc (content) as a part of key information or the entire key information. The encrypted content Kc (content) with the key information added thereto is sent to the client 12.

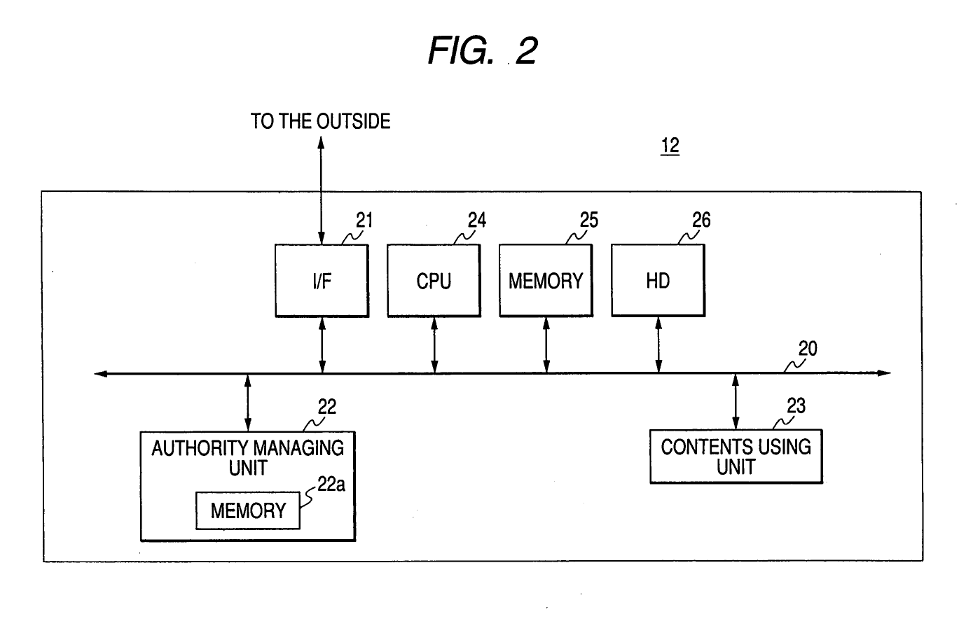

The client 12 captures the encrypted content Kc (content), in which the key information has been added to the header, via the Internet 2 through an interface (I/F) unit 21 shown in FIG. 2, and passes the encrypted content Kc (content) via a common bus 20 to a content using unit 23 serving as a decryption unit and passes the key information via the common bus 20 to an authority managing unit 22.

The authority managing unit 22 has a mechanism for preventing key information or the like from being read and used by illegal means, such as physical and electrical attacks, and has a so-called tamper resistance property. The authority managing unit 22 has a secure MMU function in order to improve security for data and includes voltage, frequency, and temperature detection circuits as a tamper resistance function for preventing electrical or physical analysis.

The authority managing unit 22 extracts the content key Kc from the key information using the key peculiar to a client apparatus. Then, the authority managing unit 22 encrypts this content key Kc for distribution using a session key Ks (Ks(Kc)) and sends the encrypted content key to the content using unit 23.

The content using unit 23 is hardware that performs common key encryption processing and content use processing. For example, when the content is music content, the content use processing in this context means processing for decrypting compressed data into PCM data and processing for further converting the PCM data into analog sound data. The content using unit 23 decrypts the encrypted content key Ks(Kc), which is sent from the authority managing unit 22, using the session key (distribution key) Ks held by the content using unit 23 to obtain the content key Kc. The content using unit 23 decrypts the encrypted content Kc (content) using this content key Kc and uses this decrypted content.

The authority managing unit 22 shows the tamper resistance function, but the interface unit 21 and the content using unit 23 cannot have such a sufficient security function. Instead, the interface unit 21 and the content using unit 23 have an ability to apply some data processing to content themselves.

A bus connecting the interface unit 21 and the authority managing unit 22 is necessary for transferring the key information. In addition, a bus connecting the interface unit 21 and the content using unit 23 is necessary for transferring the encrypted content Kc (content).

In FIG. 2, a CPU (Central Processing Unit) 24 reads out a program stored in a hard disk (HD) 26 to a memory 25 and executes various kinds of processing.

In this client 12, the authority managing unit 22 and the content using unit 23 share the session key (distribution key) Ks, which is common to all apparatuses, in advance before shipment. Consequently, when the authority managing unit 22 sends the content key Kc to the content using unit 23, the authority managing unit 22 encrypts the content key Kc with the session key Ks, which the authority managing unit 22 has. Then, the authority managing unit 22 sends the encrypted content key Ks(Kc) to the content using unit 23 via the common bus 20.

The content using unit 23, having received the encrypted content key Ks(Kc), decrypts the encrypted content key Ks(Kc) with the session key Ks, which the content using unit 23 has, to obtain the content key Kc.

In this way, the client 12 according to the first embodiment encrypts the content key Kc, which is extracted from the key information on the basis of a key peculiar to the client, using the session key Ks which is shared in advance before shipment and therefore common to all of the apparatuses, once in the authority managing unit 22, and sends this encrypted content key Ks(Kc) to the content using unit 23 via the common bus 20. Consequently, the content key Kc can be protected from an attack by a malicious third party.

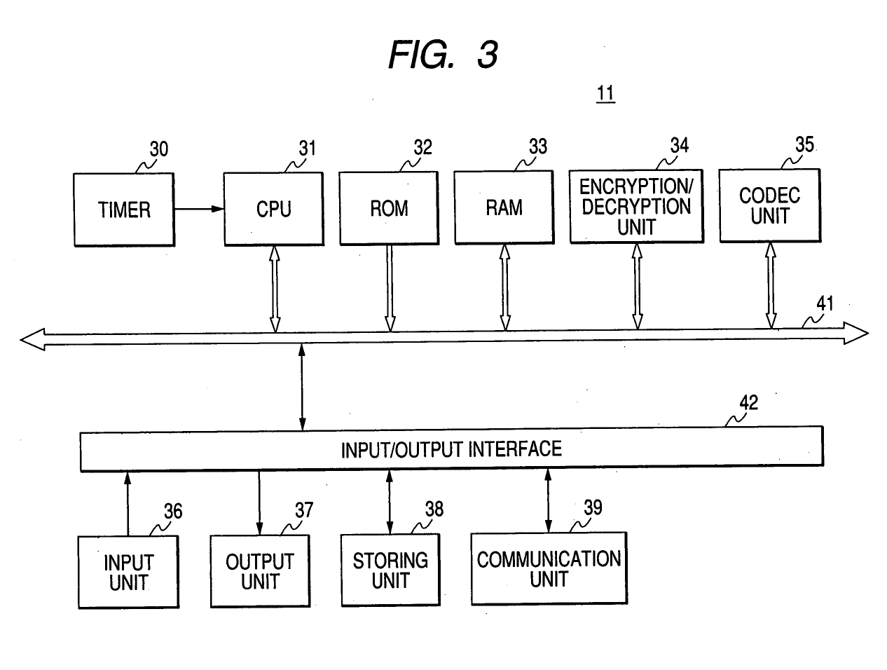

FIG. 3 shows the structure of the content server 11-A that forms part of the content provision system 1. A CPU (Central Processing Unit) 31 executes various kinds of processing in accordance with programs stored in a ROM (Read Only Memory) 32 or programs loaded in a RAM (Random Access Memory) 33 from a storing unit 38. A timer 30 performs a timing operation and supplies time information to the CPU 31. The RAM 33 also stores data and the like which are required when the CPU 31 executes the various kinds of processing according to the circumstances.

An encryption/decryption unit 34 performs processing for encrypting content data and decrypting content data that has already been encrypted. A codec unit 35 encodes content data with, for example, an ATRAC (Adaptive Transform Acoustic Coding) 3 system.

The CPU 31, the ROM 32, the RAM 33, the encryption/decryption unit 34, and the codec unit 35 are connected to each other via a bus 41. An input/output interface 42 is also connected to this bus 41.

An input unit 36 consisting of a keyboard, a mouse, or the like, a display consisting of a CRT, an LCD, or the like, an output unit 37 consisting of a speaker or the like, a storing unit 38 including a hard disk or the like, and a communication unit 39 including a modem, a terminal adapter, or the like are connected to the input/output interface 42.

The communication unit 39 performs communication processing via the Internet 2 and sends data provided from the CPU 31. In addition, the communication unit 39 outputs data received from another communicating party to the CPU 31, the RAM 33, and the storing unit 38. The storing unit 38 exchanges information with the CPU 31 and saves and deletes the information.

Various kinds of processing between the client 12 and the respective servers 11-A, 11-B, and 11-C via the Internet 2 will be hereinafter explained. These various kinds of processing are executed in the content provision system 1 as a whole shown in FIG. 1. It will be explained how a content key, which the client 12 according to this embodiment distributes while protecting it from an attack by a third party, is treated in the system as a whole.

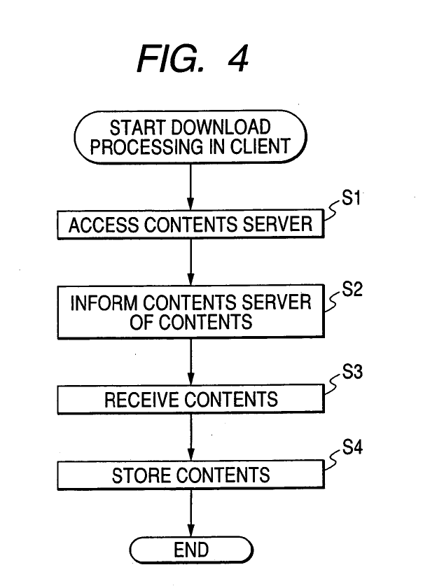

First, details of processing in which the client 12 receives content from the content server 11-A will be explained with reference to the flowchart in FIG. 4.

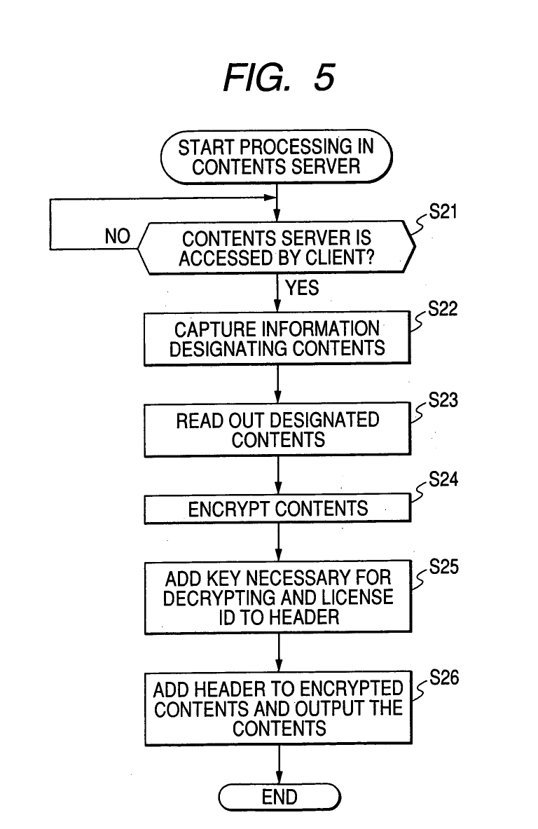

When a user instructs the client 12 to access the content server 11-A by operating an input unit of the client 12, in step S1, the CPU 24 controls the I/F unit 21 to cause the client 12 to access the content server 11-A via the Internet 2. In step S2, when the user operates the input unit to designate content to be provided, the CPU 24 receives the designation information and informs the content server 11-A of the designated content through the I/F unit 21 via the Internet 2. As described later with reference to the flowchart in FIG. 5, the content server 11-A, having been informed of the designated content, sends encrypted content data. Thus, in step S3, the CPU 24 receives this content data via the I/F unit 21, and then, in step S4, supplies the encrypted content data to the hard disk (HD) 26, causing the hard disk (HD) 26 to store the encrypted content data.

Next, content provision processing in the content server 11-A corresponding to the above-described processing in the client 12 will be explained with reference to the flowchart in FIG. 5.

In step S21, the CPU 31 of the content server 11-A is on standby until the content server 11-A is accessed by the client 12 from the Internet 2 via the communication unit 39. When the content server 11-A is accessed by the client 12, the CPU 31 proceeds to step S22 and captures information designating the content sent from the client 12. This information designating the content is the information that is sent by the client 12 in step S2 in FIG. 4.

In step S23, the CPU 31 of the content server 11-A reads out the content, which is designated by the information captured in the processing in step S22, from the content data stored in the storing unit 38. In step S24, the CPU 31 supplies the content data read out from the storing unit 38 to the encryption/decryption unit 34 and causes the encryption/decryption unit 34 to encrypt the content data using the content key Kc.

Since the content data stored in the storing unit 38 has already been encoded by the ATRAC3 system, this encoded content data is encrypted.

Note that it is needless to mention that content data can be stored in the storing unit 38 in a state in which the content data is encrypted in advance. In this case, it is possible not to perform the processing in step S24.

Next, in step S25, the CPU 31 of the content server 11-A adds content key information, which is necessary for decrypting the encrypted content, and a license ID for identifying a license, which is necessary for using the content, to a header constituting a format for transmitting the encrypted content data. In this case, the content key is encrypted on the basis of a key peculiar to a client apparatus. For example, the content key may be encrypted using a key KEKBC, which is generated from an EKB (Enabling Key Block) to be described later, and changed to KEKBC (Kc). Then, in step S26, the CPU 31 of the content server 11-A sends the content encrypted in the processing in step S24 and the data obtained by formatting the header, which has the encrypted content key and the license ID added thereto by the processing in step S25, to the client 12, which has accessed the content server 11-A, from the communication unit 39 via the Internet 2.

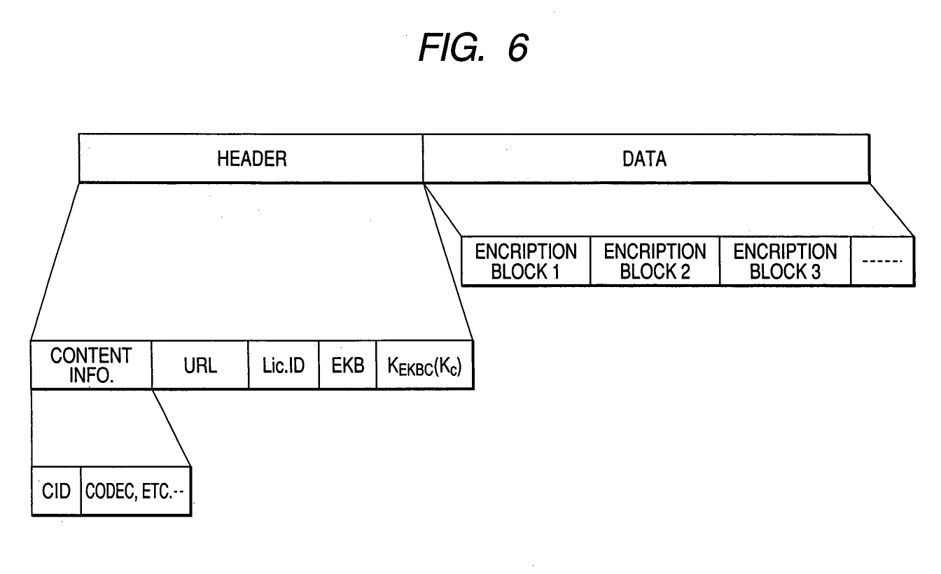

FIG. 6 shows the structure of the format when the content is supplied from the content server 11-A to the client 12 in this way. As shown in the figure, this format includes a header and data.

In the header are arranged content information, a URL (Uniform Resource Locator), an enabling key block (EKB), and data KEKBC (Kc) serving as the content key Kc, which is encrypted using the key KEKBC generated from the EKB.

The content information includes a content ID (CID) for identifying content data formatted as data and information such as a system for codec of the content.

The URL is information on an address which a user accesses when the user acquires a license defined by a license ID. In the case of the system in FIG. 1, more specifically, the URL is the address of the license server 11-B that is required for receiving a license. The license ID is an ID for identifying a license which is required when the user uses content recorded as data.

The data consists of an arbitrary number of encryption blocks. Each encryption block consists of the encrypted content Kc (content) obtained by encrypting content data with the content key Kc.

In addition, each encryption block may include an initial vector (IV), a seed, and the encrypted content Kc (content) obtained by encrypting content data with the content key Kc. Encryption in this case is performed for every eight bytes by dividing the content data into units of eight (in the case of DES) bytes. The encryption of eight bytes in a later stage is performed in a CBC (Cipher Block Chaining) mode that uses the result of the encryption of the eight bytes in the former stage.

In the case of the CBC mode, when content data of the first eight bytes is encrypted, since there is no encryption result of a prior eight bytes, the encryption is performed with the initial vector IV as the initial value.

The client 12 can acquire content from the content server 11-A as described above.

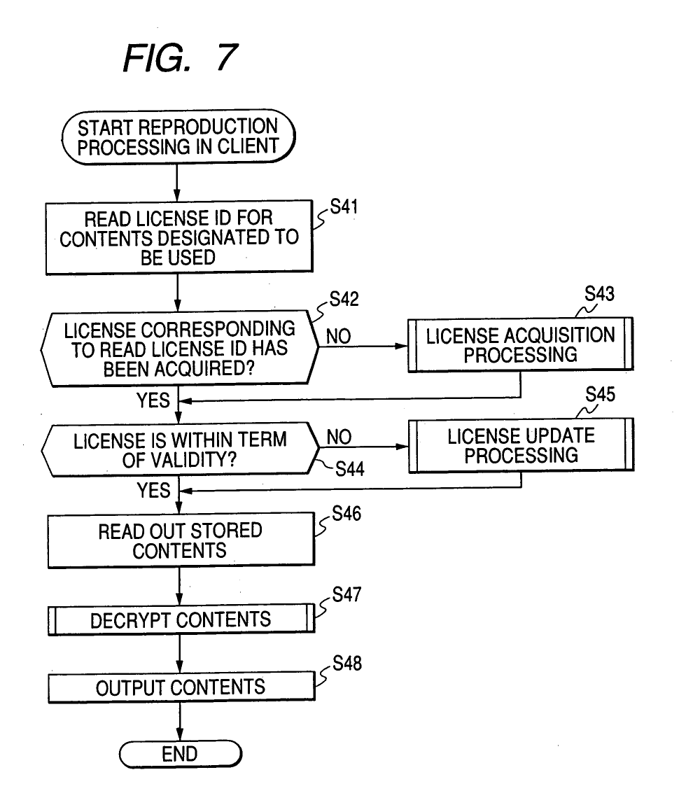

Next, the processing in the case in which the client 12 reproduces the content will be explained with reference to FIG. 7. In this processing, the decryption of the content in step S47 includes processing for encrypting the content key Kc, which the client 12 extracted with the authority managing unit 22 once using the session key Ks, and sending the encrypted content key Ks(Kc) to the content using unit 23 through the common bus 20.

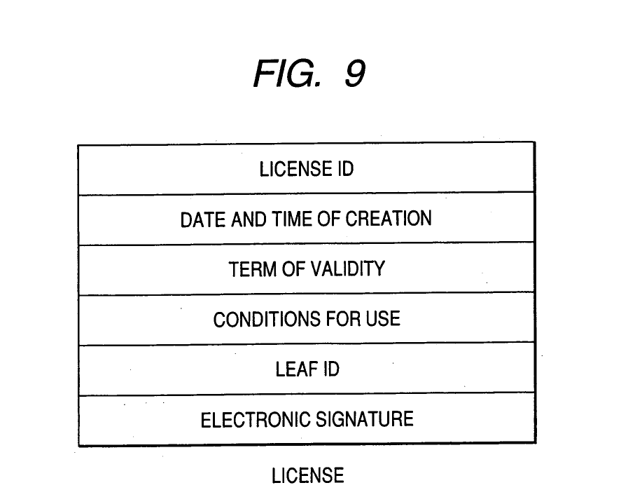

In step S41, when content is indicated, the authority managing unit 22 reads a license ID corresponding to the content (an ID of a license that is needed to use the content). As shown in FIG. 9, this license ID is described in a header of encrypted content data.

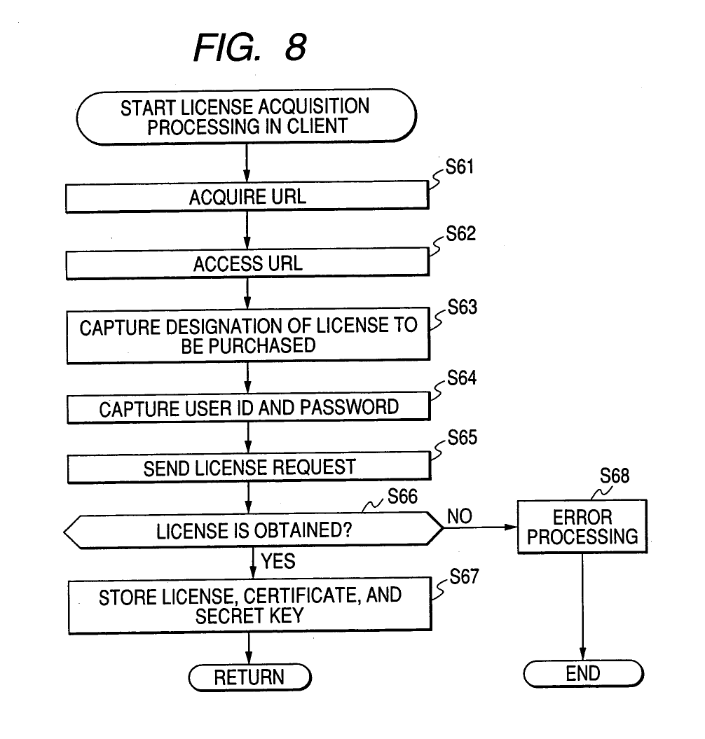

Next, in step S42, the CPU 24 determines whether the license corresponding to the license ID read in step S41 has already been acquired by the client 12 and stored in the HD 26. If the license has not been acquired, in step S43, the CPU 24 executes license acquisition processing. Details of this license acquisition processing will be described with reference to the flowchart in FIG. 8.

If it is determined in step S42 that the license has already been acquired, or if the license is acquired as a result of executing the license acquisition processing in step S43, in step S44, the authority managing unit 22 determines whether the acquired license is still valid. The authority managing unit 22 performs this determination by comparing a term of validity defined as a content of the license and time information obtained from, for example, a time server. If it is determined that the license has already expired, the authority managing unit 22 proceeds to step S45 and executes license renewal processing. Details of this license renewal processing will be described later with reference to a flowchart to be described later.

If it is determined in step S44 that the license is still valid, or if the license is renewed in step S45, in step S46, the CPU 24 reads out the encrypted content data Kc (content) from the HD 26 and causes the memory 25 to store the content data. Then, in step S47, the CPU 24 supplies the encrypted content data stored in the memory 25 to the content using unit 23 by a unit of encryption block arranged in the data in FIG. 6 and decrypts the encrypted content data using the content key Kc transferred from the authority managing unit 22.

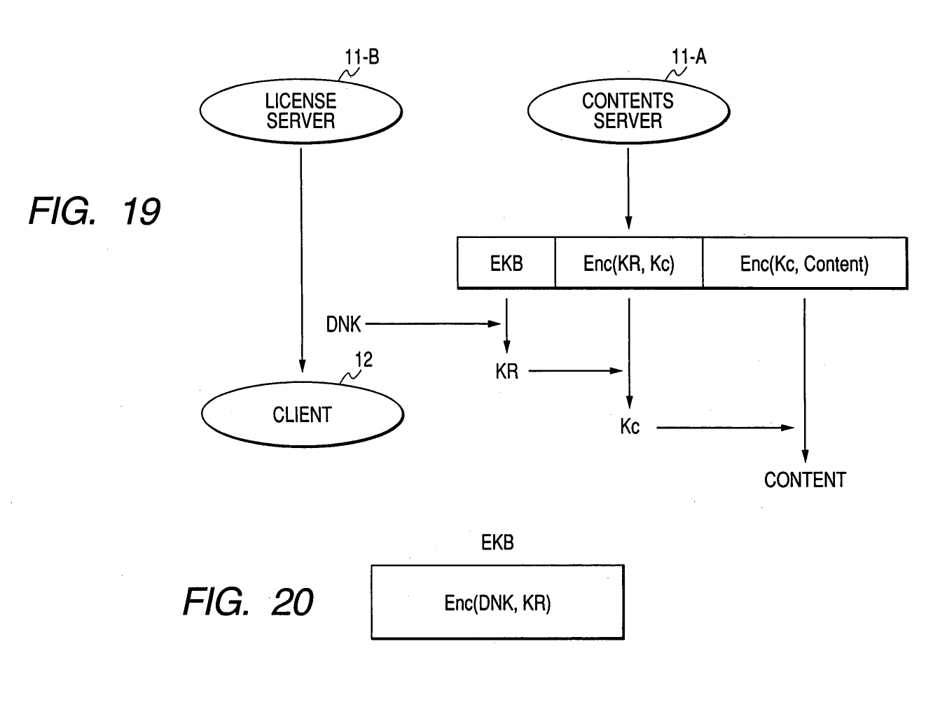

A specific example of a method of obtaining the content key Kc will be described later with reference to FIG. 19. The key KEKBC included in the EKB (FIG. 6) can be obtained using a device node key (DNK) (FIG. 19), and the content key Kc can be obtained from the data KEKBC (Kc) (FIG. 6).

In step S48, the content using unit 23 further decrypts the content data, which is decrypted by the content using unit 23, with the codes unit. Then, the content using unit 23 subjects the data decrypted by the codec unit to D/A conversion and outputs the data from a speaker.

Next, details of the license acquisition processing, which is performed in step S43 in FIG. 7, will be explained with reference to the flowchart in FIG. 8.

The client 12 acquires service data including a leaf ID, a DNK (Device Node Key), a pair of a secret key and a public key of the client 12, a public key of a license server, and a certificate of each public key by registering the service data in the license server 11 -B in advance.

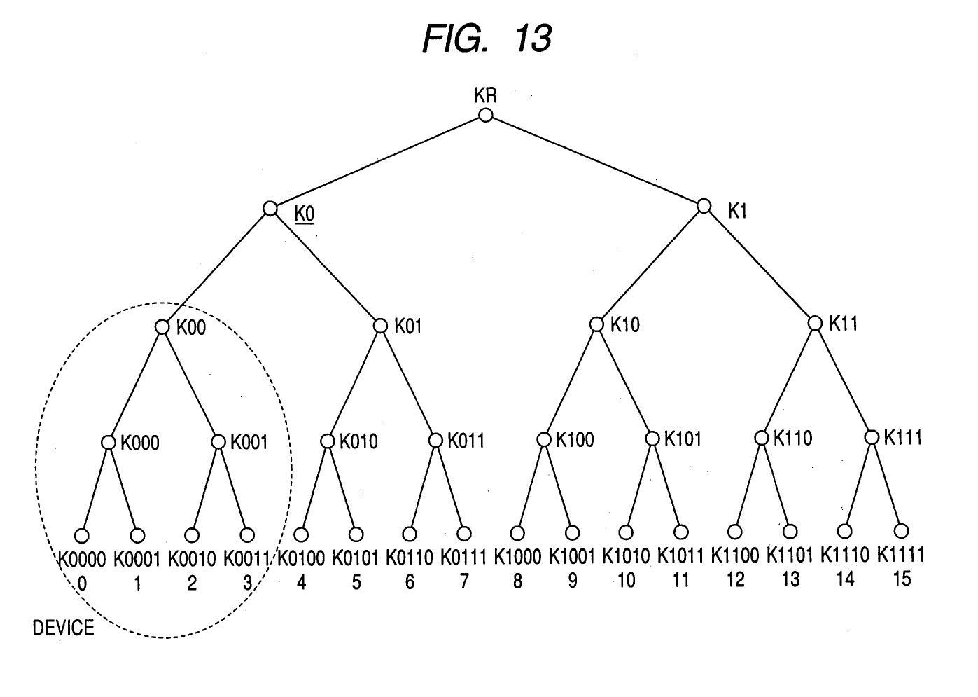

The leaf ID represents identification information assigned for each client, and the DNK represents a device node key (described later with reference to FIG. 13) that is needed to decrypt the encrypted content key Kc (data KEKBC (Kc)) included in the EKB (enabling key block) corresponding to the license.

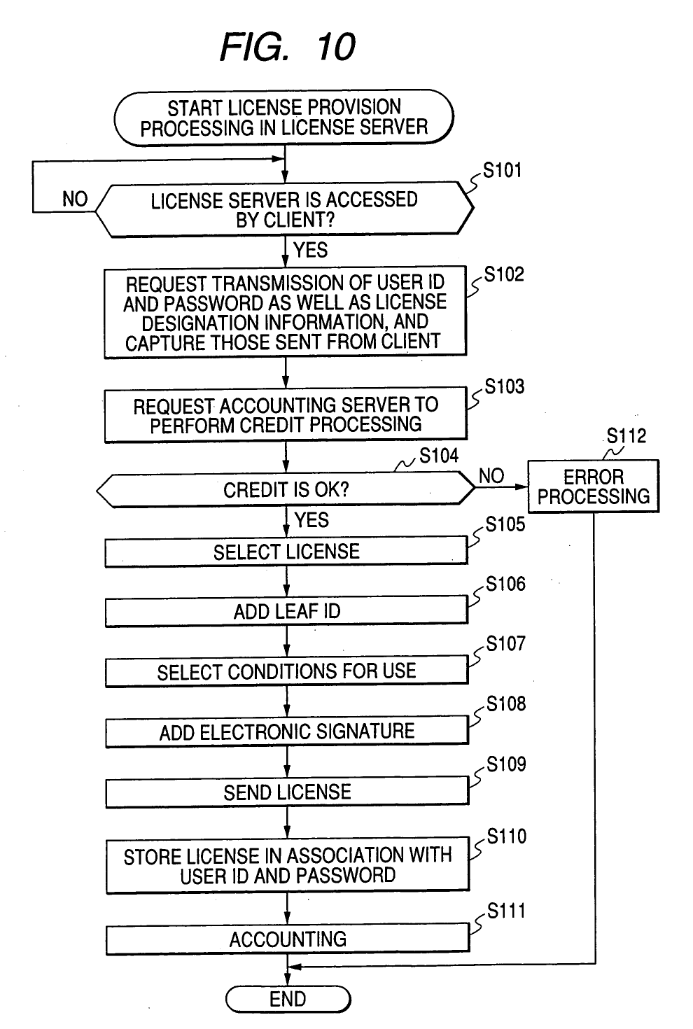

First, in step S61, the CPU 24 acquires a URL corresponding to the license ID, which is set as an object of processing now, from the header shown in FIG. 6. As described above, this URL is an address that should be accessed when a license corresponding to the license ID also described in the header is obtained. Thus, in step S62, the CPU 24 accesses the URL acquired in step S61. More specifically, the client 12 accesses the license server 11-B through the I/F unit 21 via the Internet 2. In this case, the license server 11-B requests the client 12 to input license designation information designating a license to be purchased (a license necessary for using content), a user ID, and a password (step S102 in FIG. 10 to be described later). The CPU 24 causes a not-shown display section of the output unit to display this request. The user operates the input unit on the basis of this display to input the license designation information, the user ID, and the password. Note that the user of the client 12 has acquired the user ID and the password in advance by accessing the license server 11-B via the Internet 2.

In steps S63 and S64, the CPU 24 captures the license identification information input from the input unit and also captures the user ID and the password. In step S65, the CPU 24 controls the I/F 21 to send a license request including the input user ID and password, the license designation information, and a leaf ID included in service data (to be described later) to the license server 11-B via the Internet 2.

As described later with reference to FIG. 10, the license server 11-B sends a license on the basis of the user ID, the password, and the license designation information (step S109), or if conditions are not satisfied, the license server 11-B does not send a license (step S 12).

In step S66, the CPU 24 determines whether a license has been sent from the license server 11-B. If a license has been sent from the license server 11-B, the CPU 24 proceeds to step S67, supplies the license to the HD 26, and causes the HD 26 to store the license.

If it is determined in step S66 that a license has not been sent from the license server 11-B, the CPU 24 proceeds to step S68 and executes error processing.

As described above, each client 12 is capable of using content only after the client 12 acquires a license corresponding to a license ID incidental to the content data. Note that it is also possible to perform the license acquisition processing in FIG. 8 before the user acquires the content.

The license provided to the client 12 includes, for example, conditions for use (usage right) and a leaf ID as shown in FIG. 9.

The conditions for use include information indicating a use period in which the content can be used on the basis of the license, a download period in which the content can be downloaded on the basis of the license, the number of times the content can be copied (allowed number of times of copy), the number of times of checkout, a maximum number of times of checkout, a right allowing the user to record the content in a CD-R on the basis of the license, the number of times the content can be copied to a PD (Portable Device), a right allowing the user to change the license to an ownership (purchased state), a duty of keeping a use log, and the like.

Next, the license provision processing in the license server 11-B, which is executed in association with the license acquisition processing in the client 12 in FIG. 8, will be explained with reference to the flowchart in FIG. 10. Note that, in this case, the structure of the content server 11-A in FIG. 3 is referred to as the structure of the license server 11-B.

In step S101, the CPU 31 of the license server 11-B is on standby until the license server 11-B is accessed by the client 12. When the license server 11-B is accessed, the CPU 31 proceeds to step S102 and requests the client 12, which has accessed the license server 11-B, to send a user ID, a password, and license designation information. As described above, when a user ID, a password, a leaf ID, and license designation information (license ID) are sent from the client 12 in the processing in step S65 in FIG. 8, the CPU 31 of the license server 11-B receives the user ID, the password, the leaf ID, and the license designation information (license ID) through the communication unit 39 and executes processing for capturing them.

Then, in step S103, the CPU 31 of the license server 11-B accesses the accounting server 11-C from the communication unit 39 and requests credit processing for the user corresponding to the user ID and the password. When the request for credit processing is received from the license server 11-B via the Internet 2, the accounting server 11-C checks the past payment history of the user corresponding to the user ID and the password to find, for example, whether the user has ever been in default of payment of consideration for a license. If the user has never been in default, the accounting server 11-C sends a credit result allowing a license to be granted to the user. If the user has been in default, the accounting server sends a credit result not allowing a license to be granted to the user.

In step S104, the CPU 31 of the license server 11-B determines whether the credit result from the accounting server 11-C allows a license to be granted to the user. If the granting of a license is allowed, the CPU 31 proceeds to step S105 and extracts a license, which corresponds to the license designation information captured in the processing in step S102, from licenses stored in the storing unit 38. Information such as a license ID, a version, a date and time of creation, and a term of validity are described in advance for the licenses stored in the storing unit 38. In step S106, the CPU 31 adds the received leaf ID to the license. Moreover, in step S107, the CPU 31 selects conditions for use associated with the license selected in step S105. Alternatively, if conditions for use are designated by the user in the processing in step S102, those conditions for use are added to conditions for use prepared in advance if necessary. The CPU 31 adds the selected conditions for use to the license.

In step S108, the CPU 31 signs the license with the secret key of the license server. Consequently, a license with a structure as shown in FIG. 9 is generated.

Next, the CPU 31 of the license server 11-B proceeds to step S109 and causes the communication unit 39 to send the license (having the structure shown in FIG. 9) to the client 12 via the Internet 2.

In step S110, the CPU 31 of the license server 11-B causes the storing unit 38 to store the license (including the conditions for use and the leaf ID) just sent in the processing in step S109 in association with the user ID and the password captured in the processing in step S 102. Moreover, in step S111, the CPU 31 executes accounting. More specifically, the CPU 31 requests the accounting server 11-C to perform accounting for the user corresponding to the user ID and the password. The accounting server 11-C executes accounting for the user on the basis of the request for accounting.

As described above, in the event that the user does not make payment in response to the accounting, the user cannot thereafter receive a license even if the user requests the grant of a license. In other words, in this case, since a credit result not allowing the granting of a license to the user is sent from the accounting server 11-C, the CPU 31 proceeds from step S104 to step S112 and executes error processing. More specifically, the CPU 31 of the license server 11-B controls the communication unit 39 to output a message to the client 12 that has accessed the license server 11-B indicating that a license cannot be granted. In this case, as described above, since the client 12 cannot receive a license, the client 12 cannot use the content (decrypt a cipher).

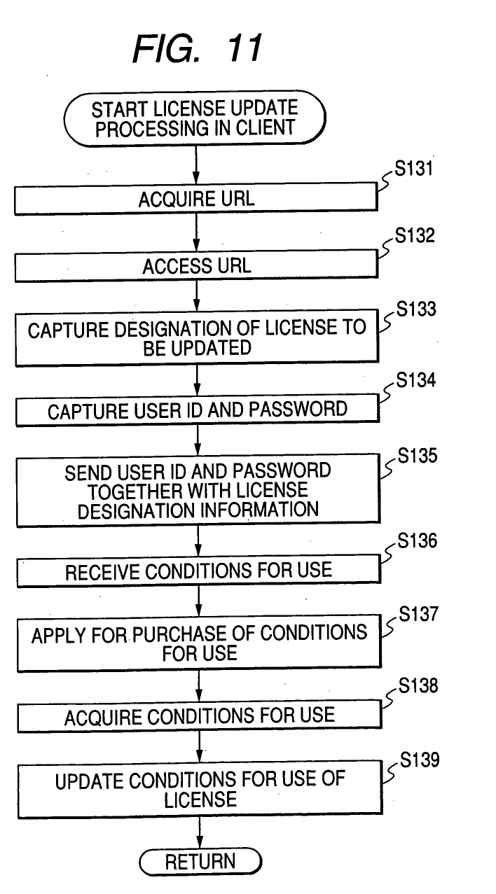

FIG. 11 shows details of the license renewal processing in step S45 in FIG. 7. The processing in steps S131 to 135 in FIG. 11 is basically the same as the processing in steps S61 to S65 in FIG. 8. However, in step S133, the CPU 24 captures the license ID of a license to be renewed rather than a license to be purchased. Then, in step S135, the CPU 24 sends the license ID of the license to be renewed to the license server 11-B together with the user ID and the password.

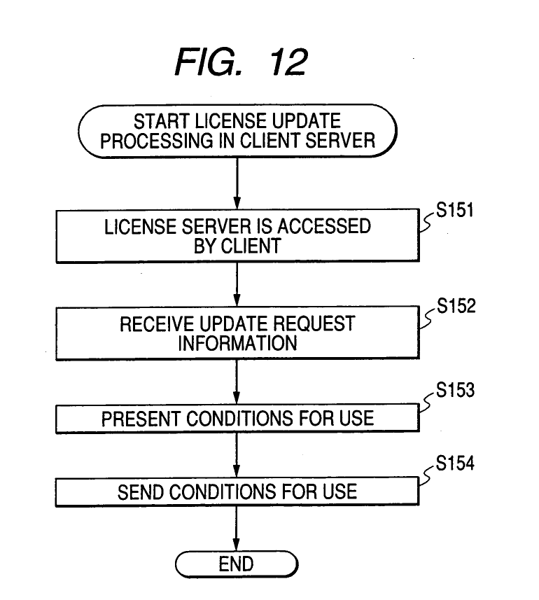

In response to the transmission processing in step S135, the license server 11-B presents conditions for use as described later (step S153 in FIG. 12). Thus, in step S136, the CPU 24 of the client 12 receives the conditions for use from the license server 11-B and outputs the conditions for use to the display section of the output unit to cause the output unit to display the same. The user operates the input unit to select a predetermined condition for use out of the displayed conditions for use and add a predetermined condition for use anew. In step S 137, the CPU 24 sends an application for purchasing the conditions for use (conditions for renewing the license) selected as described above to the license server 11-B. In response to this application, as described later, the license server 11-B sends final conditions for use to the client 12 (step S154 in FIG. 12). Thus, in step S138, the CPU 24 of the client 12 acquires the conditions for use from the license server 11-B. In step S139, the CPU 24 renews the conditions for use as conditions for use of the corresponding license already stored in the HD 26.

FIG. 12 shows license renewal processing that the license server 11-B executes in response to the license renewal processing in the client 12.

First, when the license server 11-B is accessed by the client 12 in step S151, in step S152, the CPU 31 of the license server 11-B receives the license designation information, which the client 12 has sent in step S135, together with license renewal request information.

In step S153, when the CPU 31 receives a renewal request for a license, the CPU 31 reads out conditions for use corresponding to the license (conditions for use to be renewed) from the storing unit 38 and sends the conditions for use to the client 12.

As described above, when the client 12 applies for the purchase of the conditions for use in the processing in step S137 in FIG. 11 in response to this presentation of the conditions for use, in step S154, the CPU 31 of the license server 11-B generates data corresponding to the conditions for use. In step S154, the CPU 31 sends the data to the client 12. The client 12 renews the conditions for use of the license already registered using the received conditions for use as described above.

In the content provision system 1, for example, as shown in FIG. 13, the keys of devices and licenses are managed on the basis of the principle of a broadcast encryption system. The keys are arranged in a hierarchical tree structure, and leaves at a lowermost level correspond to the keys of the respective devices. In the case of the example of FIG. 13, keys corresponding to sixteen devices (clients) or licenses with numbers 0 to 15 are generated.

The respective keys are defined in association with respective nodes of the tree structure indicated by circles in the figure. In this example, a root key KR corresponds to a root node at an uppermost level, keys K0 and K1 correspond to nodes at a second level, keys K00 to K11 correspond to nodes at a third level, and keys K000 to K111 correspond to nodes at a fourth level, respectively. Further, keys K0000 to K1111 correspond to the leaves (device nodes) serving as nodes at the lowermost level, respectively.

Since the keys are arranged in the tree structure, for example, it is assumed that a key superior to the keys K0010 and K0011 is K001, and a key superior to the keys K000 and K001 is K00. In the same manner, it is assumed that a key superior to the keys K00 and K01 is K0, and a key superior to the keys K0 and K1 is KR.

The content key Kc for using content is managed by the keys corresponding to the respective nodes of one path from the device node (leaf) at the lowermost level to the root node at the uppermost level. For example, the content key Kc for using content is managed by the respective keys of a path including the keys K0011, K001, K00, K0, and KR on the basis of a license corresponding to the node (leaf ID) with the number 3.

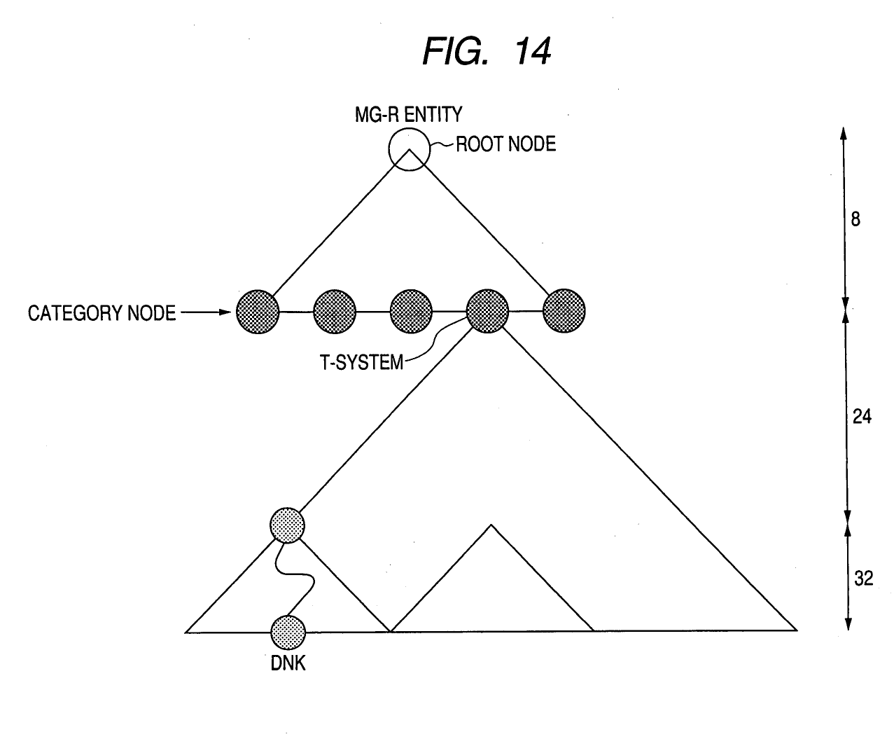

In a system to which the present invention is applied, as shown in FIG. 14, keys of devices and keys of licenses are managed by a key system constituted on the basis of the principle shown in FIG. 13. In the example of FIG. 14, nodes of 8+24+32 levels are arranged in a tree structure. Categories are associated with the respective nodes from a root node to the subordinate eight levels. Categories in this context means, for example, the category of an apparatus using a semiconductor memory, such as a Memory Stick (trademark), and the category of an apparatus that receives digital broadcasts. Further, a T system corresponds to one node of the category nodes as a system for managing a license.

In other words, a license is defined by keys corresponding to nodes of twenty-four levels of a hierarchy lower than the nodes of this T system. In the case of this example, 224 (about 16 megabytes) licenses can be defined. Moreover, 232 (about 4 gigabytes) users (or clients 12) can be defined by a hierarchy of the lowermost thirty-two levels. It is assumed that keys corresponding to the lowermost thirty-two levels constitute DNKs (Device Node Keys), and IDs corresponding to the leaves at the lowermost level are leaf IDs.

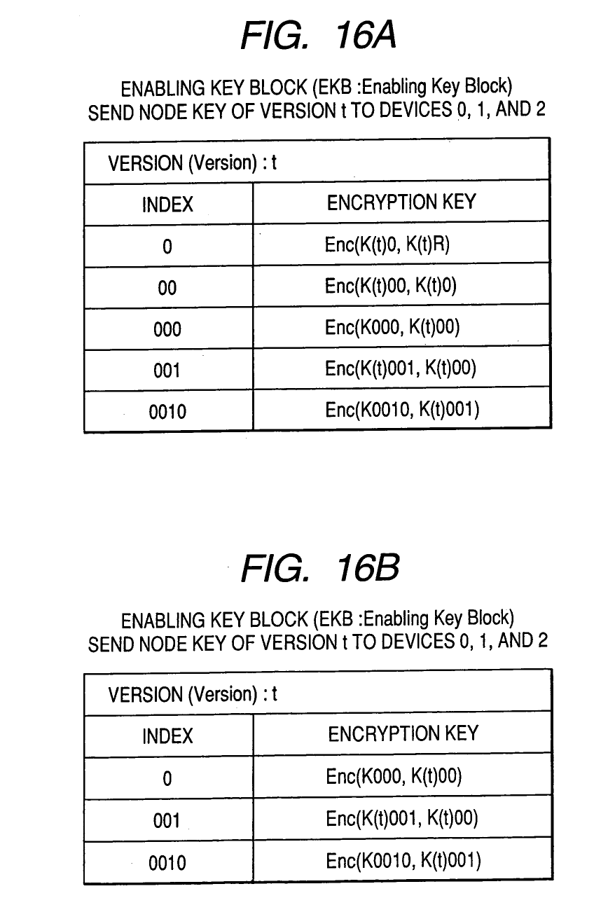

The keys of the respective devices and licenses are associated with one of the paths constituted by the respective nodes of sixty-four (=8+24+32) levels. For example, a content key obtained by encrypting content is encrypted using keys corresponding to nodes constituting a path assigned to a license corresponding to the content key. A key of an upper hierarchy is encrypted using a key of an immediately lower hierarchy and arranged in an EKB (to be described later with reference to FIG. 16). A DNK at the lowermost level is not arranged in the EKB but is described in service data and given to the client 12 of the user. The client 12 uses the DNK described in the license to decrypt a key of an immediately upper hierarchy described in the EKB (FIG. 16) to be distributed together with content data and uses the decrypted key to decrypt a key at an upper hierarchy thereof described in the EKB. By sequentially performing this processing, the client 12 can obtain all the keys belonging to the paths of the license.

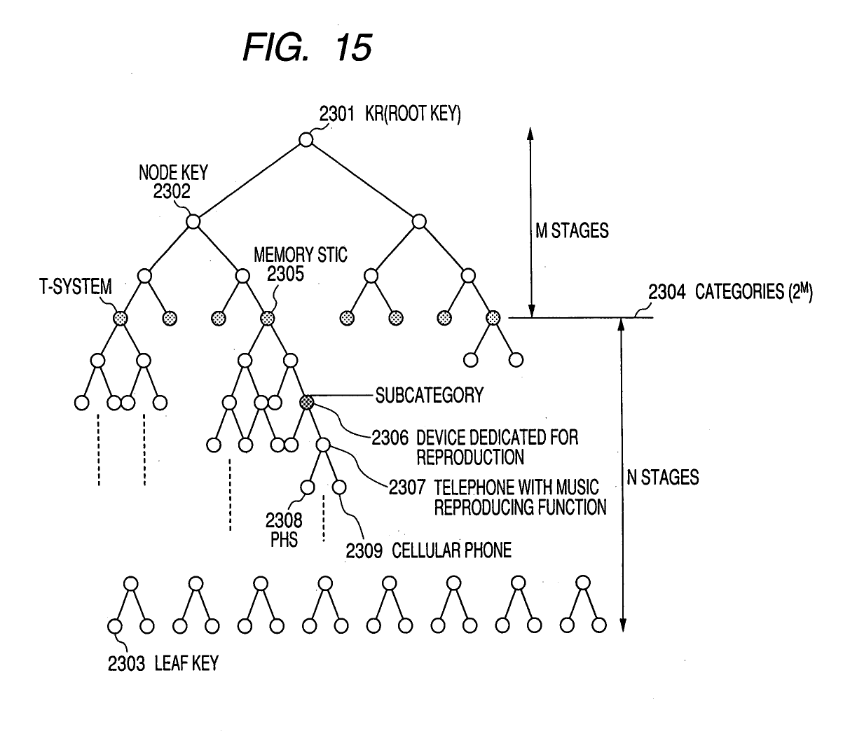

FIG. 15 shows a specific example of a classification of categories of a hierarchical tree structure. In FIG. 15, a root key KR 2301 is set at an uppermost level of the hierarchical tree structure, node keys 2302 are set in intermediate levels below the uppermost level, and leaf keys 2303 are set at a lowermost level. Respective devices own the respective leaf keys, the series of node keys between the leaf keys and the root key, and the root key.

Predetermined nodes from the uppermost level to an Mth level (M=8 in the example of FIG. 14) are set as category nodes 2304. In other words, respective nodes at the Mth level are set as device setting nodes of a specific category. With one node at the Mth level as a vertex, nodes and leaves at M+1^{st} level and lower levels are set as nodes and leaves for devices included in the category.

For example, a category “Memory Stick (trademark)” is set for one node 2305 at the Mth level in FIG. 15, and nodes and leaves continuing below this node are set as nodes or leaves dedicated for categories including various devices that use memory sticks. In other words, the node 2305 and the nodes below the node 2305 are defined as a set of related nodes and leaves of devices defined in the category of the Memory Stick.

Further, a level lower than the Mth level by several levels can be set as a subcategory node 2306. In the example of FIG. 15, a node 2306 of “Device Dedicated for Reproduction” is set as a subcategory node included in the category of devices that use the Memory Stick. Moreover, a node 2307 of a “Telephone With Music Reproducing Function” included in the subcategory of Device Dedicated for Reproduction is set below the subcategory node 2306. A “PHS” node 2308 and a “Cellular Phone” node 2309, which are included in the category of the Telephone With Music Reproducing Function, are set below the node 2307.

Moreover, it is possible to set categories and subcategories according to not only a type of a device, but also, for example, to a node individually managed by a manufacturer, a content provider, a settlement institution, or the like, that is, by an arbitrary unit such as a unit of processing, a unit of control, or a unit of provided service (these units will be hereinafter collectively referred to as entities). For example, if one category node is set as a vertex node dedicated for a game device XYZ sold by a game device manufacturer, it becomes possible to sell the game device XYZ with node keys and leaf keys in lower levels below the vertex node stored in the game device XYZ sold by the manufacturer. Thereafter, distribution of encrypted content, distribution of various keys, or renewal processing is performed by generating an enabling key block (EKB) constituted by the node keys and the leaf keys below the vertex node key. This makes it possible to distribute data that is usable only for devices below the vertex node.

In this way, with one node as a vertex, nodes below the vertex node are set as related nodes of categories or subcategories defined for the vertex node. Consequently, a manufacturer, a content provider, or the like, which manages one vertex node of a category level or a subcategory level, can individually generate an enabling key block (EKB) with the node as a vertex and distribute the enabling key block to devices belonging to a node below the vertex node. Thus, renewal of keys can be executed without affecting devices which belong to nodes of other categories not belonging to the vertex node.

For example, in the tree structure shown in FIG. 13, four devices 0, 1, 2, and 3 included in one group own common keys K00, K0, and KR as node keys. It becomes possible to provide a common content key only to the devices 0, 1, 2, and 3 by using this node key sharing constitution. For example, if the commonly owned node key K00 itself is set as a content key, only the devices 0, 1, 2, and 3 are capable of setting a common content key without executing a new key transmission. In addition, if a value Enc (K00, Kc) obtained by encrypting the new content key Kc with the node key K00 is stored in a recording medium via a network and distributed to the devices 0, 1, 2, and 3, only the devices 0, 1, 2, and 3 are capable of deciphering the cipher Enc (K00, Kc) using the common node key K00 owned by the respective devices to obtain the content key Kc. Note that Enc (Ka, Kb) indicates data that is obtained by encrypting Kb with Ka.

In addition, at a certain point in time t, when it is detected that the keys K001, K001, K00, K0, and KR owned by the device 3 have been analyzed and revealed by an attacker (hacker), in order to protect data to be sent and received in the system (a group of the devices 0, 1, 2, and 3) after that point, it is necessary to separate the device 3 from the system. For that purpose, it is necessary to renew the node keys K001, K00, K0, and KR to new keys K(t)001, K(t)00, K(t)0, and K(t)R, respectively, and to inform the devices 0, 1, and 2 of the renewed keys. Here, K(t)aaa indicates a renewed key in a generation t of a key Kaaa.

Distribution processing for a renewed key will be explained. Renewal of a key is executed, for example, by supplying a table, which consists of block data called an enabling key block (EBK), such as that shown in FIG. 16A, to the devices 0, 1, and 2 via a network or storing the table in a recording medium. Note that the enabling key block (EKB) includes an encryption key for distributing a key, which is renewed anew, to devices corresponding to the respective leaves (nodes at the lowermost level) forming the tree structure as shown in FIG. 13. The enabling key block (EKB) may also be called a key renewal block (KRB).

The enabling key block (EKB) shown in FIG. 16A is constituted as block data having a data structure that only a device requiring renewal of a node key can renew. An example of FIG. 16A is block data that is formed for the purpose of distributing a renewed node key of a generation t in the devices 0, 1, and 2 in the tree structure shown in FIG. 13. As is evident from FIG. 13, the devices 0 and 1 need K(t)00, K(t)0, and K(t)R as renewed node keys, and the device 2 needs K(t)001, K(t)00, K(t)0, and K(t)R as renewed node keys.

As shown in the EKB in FIG. 16A, the EKB includes plural encryption keys. An encryption key at a lowermost stage of FIG. 16A is Enc(K0010, K(t)001). This is a renewed node key K(t)001 encrypted by the leaf key K0010 that the device 2 has. The device 2 can decrypt this encryption key with the leaf key K0010, which the device 2 itself has, and obtain a renewed node key K(t)001. In addition, the device 2 is capable of decrypting the encryption key Enc(K(t)001, K(t)00) at a second row from the bottom in FIG. 16A using the renewed node key K(t)001 obtained by the previews decrypting step and can obtain the renewed node key K(t)00.

Then, the renewed node key K(t)0 is obtained by decrypting an encryption key Enc(K(t)00, K(t)0) at a second row from the top in FIG. 16A, and the renewed root key K(t)R is obtained by decrypting an encryption key Enc(K(t)0, K(t)R) in the first row at the top in FIG. 16A using the renewed node key K(t)0.

On the other hand, the node key K000 is not included in an object to be renewed, and what the nodes 0 and 1 need as renewed node keys are K(t)00, K(t)0, and K(t)R. The nodes 0 and 1 decrypt an encryption key Enc(K000, K(t)00) at a third row from the top in FIG. 16A using the device keys K0000 and K0001 to thereby acquire the renewed node key K(t)00. Then, the nodes 0 and 1 decrypt an encryption key Enc(K(t)00, K(t)0) at a second row from the top in FIG. 16A to thereby obtain the renewed node key K(t)0, and decrypt an encryption key Enc(K(t)0, K(t)R) in the first row at the top in FIG. 16A to thereby obtain the renewed root key K(t)R. In this way, the devices 0, 1, and 2 can obtain the renewed key K(t)R.

Note that indexes of FIG. 16A indicate absolute addresses of node keys and leaf keys that are used as decrypting keys for decrypting encryption keys on the right side in the figure.

When the renewal of the node keys K(t)0 and K(t)R at upper levels in the tree structure shown in FIG. 13 is unnecessary and renewal processing for only the node key K00 is necessary, the renewed node key K(t)00 can be distributed to the devices 0, 1, and 2 using the enabling key block (EKB) of FIG. 16B.

The EKB shown in FIG. 16B is usable, for example, in the case in which a new content key, which is shared in a specific group, is distributed. As a specific example, it is assumed that the devices 0, 1, 2, and 3 in the group indicated by a dotted line in FIG. 13 use a certain recording medium and requires a new common content key K(t)con. In this case, data Enc(K(t)00, K(t)con) obtained by encrypting the new common renewed content key K(t)c using the key K(t)00, which is obtained by renewing the common node key K00 of the devices 0, 1, 2, and 3, is distributed together with the EKB shown in FIG. 16B. Through this distribution, it becomes possible to distribute the data as data that devices of the other groups, such as a device 4, cannot decrypt.

In other words, if cryptography is decrypted using the key K(t)00 obtained by processing the EKB, the devices 0, 1, and 2 are capable of obtaining the content key K(t)con at a point in time t.

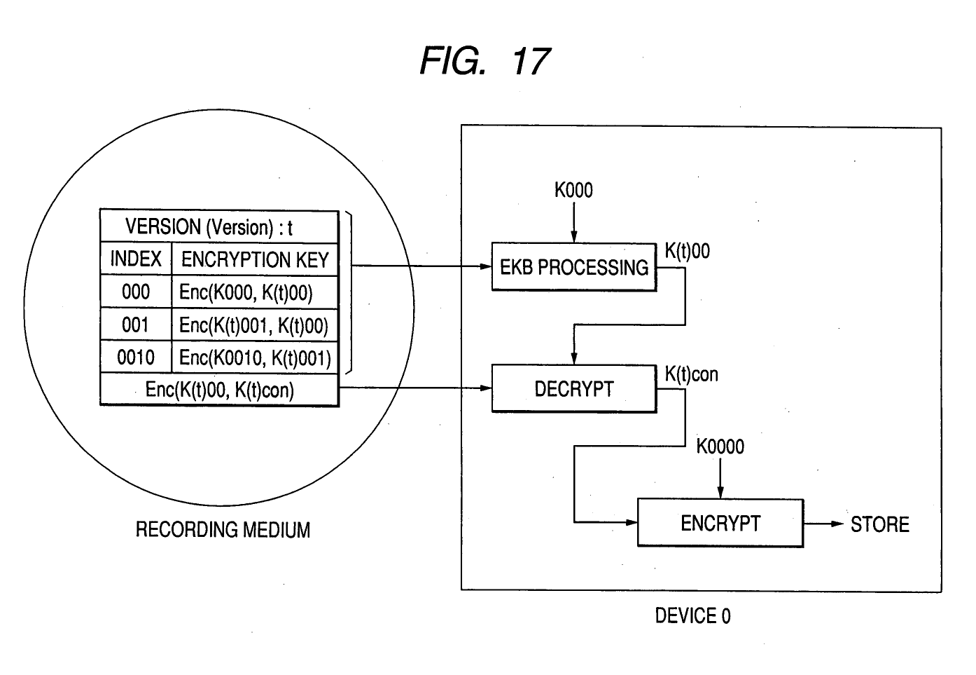

As an example of processing for obtaining the content key K(t)con at the point in time t, FIG. 17 shows the processing of the device 0 that has received the data Enc(K(t)00, K(t)c), which is obtained by encrypting the new common content key K(t)con using K(t)00, and the EKB shown in FIG. 16B via a recording medium. In other words, this example is an example in which encryption message data according to the EKB is set as the content key K(t)con.

As shown in FIG. 17, the device 0 generates the node key K(t)00 according to the same EKB processing as described above using the EKB at the point of generation t stored in the recording medium and the node key K000 that the device 0 itself stores in advance. Moreover, the device 0 decrypts the renewed content key K(t)con using the decrypted renewed node key K(t)00 and, later, encrypts the content key K(t)con with the leaf key K0000, which only the device 0 has, and stores the encrypted content key K(t)con in order to use the same.

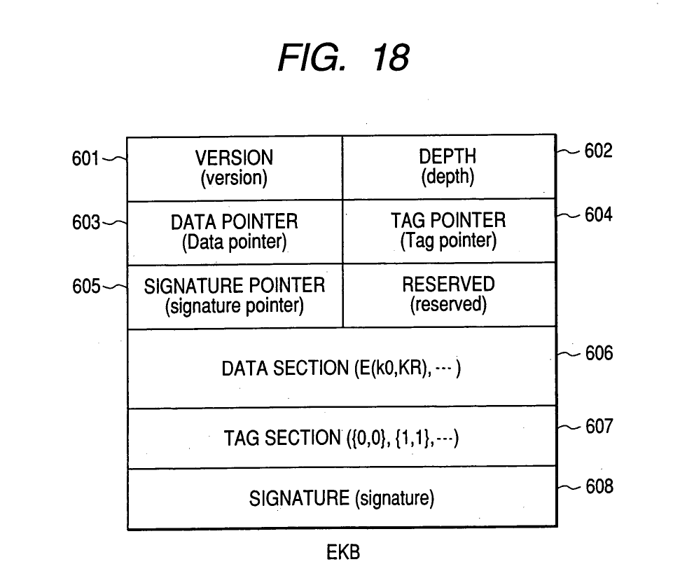

FIG. 18 shows an example of a format of the enabling key block (EKB). A version 601 is an identifier indicating the version of the enabling key block (EKB). Note that the version has a function of identifying a latest EKB and a function of indicating a correspondence relationship between the EKB and content. A depth indicates the number of hierarchies of a hierarchical tree with respect to a device that is a distribution destination of the enabling key block (EKB). A data pointer 603 is a pointer indicating the position of a data section 606 in the enabling key block (EKB). A tag pointer 604 is a pointer indicating the position of a tag section 607. A signature pointer 605 is a pointer indicating the position of a signature 608.

The data section 606 stores, for example, data obtained by encrypting a node key to be renewed. For example, the data section 606 stores the respective encryption key or the like concerning renewed node keys as shown in FIG. 17.

The signature 608 is an electronic signature that is executed by, for example, a key management center (licenser server 11-B), the content provider (content server 11-A), the settlement institution (accounting server 11-C), or the like that has issued the enabling key block (EKB). A device having received the EKB confirms that the EKB has been issued by a legitimate enabling key block (EKB) issuer according to signature verification.

The processing for using the content supplied from the content server 11-A on the basis of the license supplied from the license server 11-B as described above is summarized as shown in FIG. 19.

In other words, the content is supplied from the content server 11-A to the client 12, and the license is supplied from the license server 11-B to the client 12. The content has been encrypted by the content key Kc (Enc(Kc, Content)), and the content key Kc is encrypted by the root key KR (which is a key obtained from the EKB and corresponds to the key KEKBC in FIG. 6) (Enc(KR, Kc)) and added to the encrypted content to be provided to the client 12.

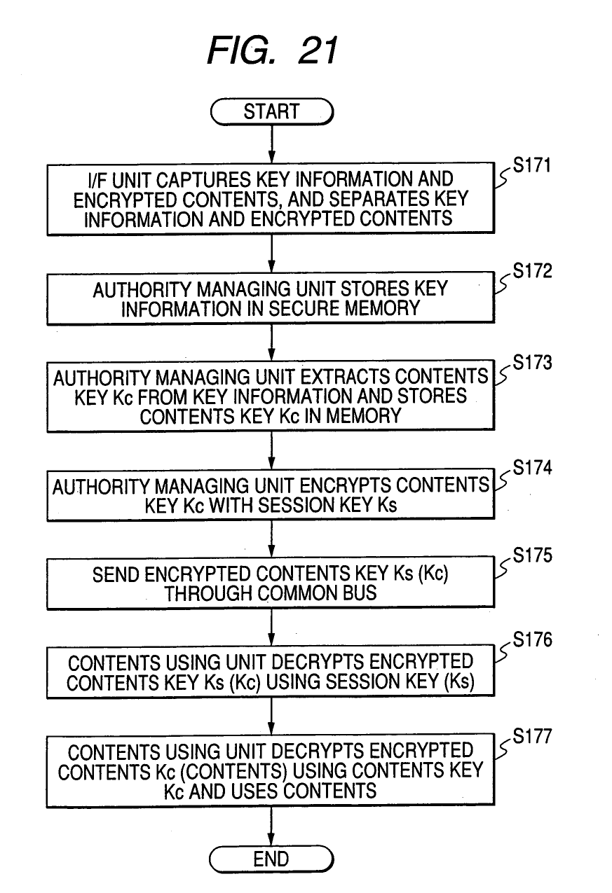

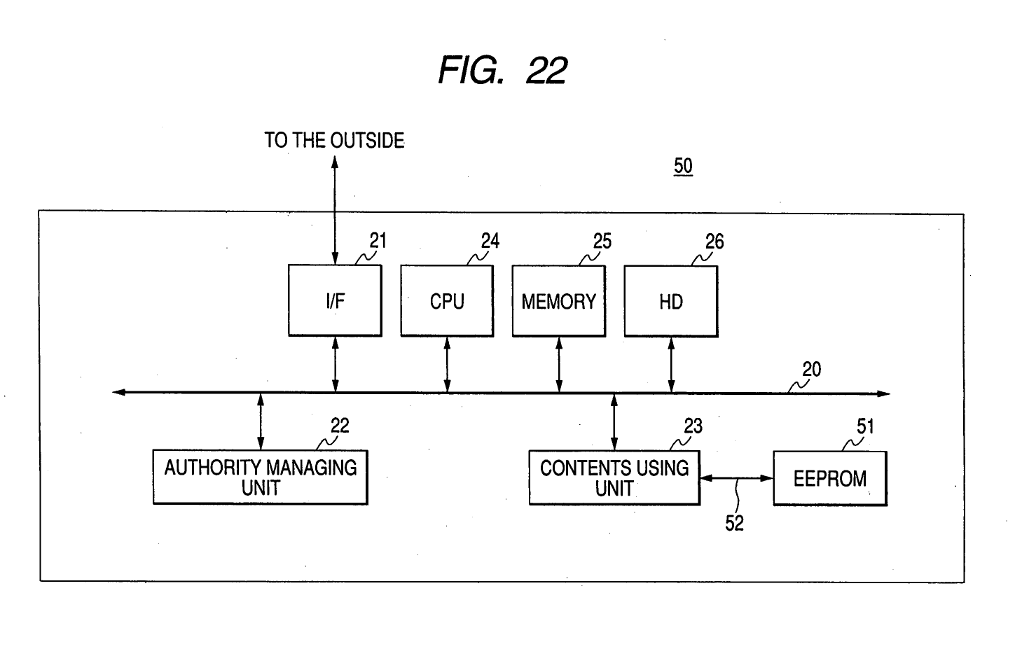

As shown in FIG. 20, the EKB in the example of FIG. 19 includes the root key KR encrypted by the DNK (Enc(DNK, KR)). Therefore, the client 12 can obtain the root key KR from the EKB using the DNK included in service data with the authority managing unit 22. Moreover, the authority managing unit 22 can decrypt the content key Kc from the Enc(KR, Kc) using the root key KR. Then, according to the method of the present invention, the authority managing section 22 encrypts the content key Kc with the session key Ks, sends the encrypted content key Ks(Kc) to the content using unit 23, decrypts the content key using the session key Ks in the content using unit 23, and decrypts content from the Enc(Kc, Content) using this content key Kc. This processing for decrypting the content has already been explained as step S47 in FIG. 7. However, the processing will be hereinafter explained in detail with reference to FIG. 21.

First, the I/F unit 21 of the client 12 captures the key information and the encrypted content Kc (content) sent from the content server 11-A. Then, the I/F unit 21 passes the encrypted content Kc (content) to the content using unit 23 serving as a decryption unit and passes the key information to the authority managing unit 22, respectively, via the common bus 20 (step S171).

Next, the authority managing unit 22 of the client 12 stores the key information in the memory 22a (step S172). The authority managing unit 22 decrypts the content key Kc from the Enc(KR, Kc) of the key information using the root key KR as described with reference to FIGS. 19 and 20 (step S173). The authority managing unit 22 also stores this content key Kc in the memory 22a. In addition, the authority managing unit 22 encrypts the content key Kc stored in the memory 22a with the session key Ks that the authority managing unit 22 received at the time of shipment in advance (step S174). The authority managing unit 22 also stores this encrypted content key Ks(Kc) in the memory 22a.

Next, the encrypted content key Ks(Kc) is sent to the content using unit 23 from the authority managing unit 22 via the common bus 20 (step S175).

Then, the content using unit 23 decrypts the encrypted content key Ks(Kc) using the session key Ks that the content using unit 23 received in advance at the time of shipment (step S176), decrypts the encrypted content Kc(content) using this content key Kc, and uses the content (step S177).

In this way, the client 12 according to the first embodiment encrypts the content key Kc, which is extracted from the key information, once using the shared session key Ks in the authority managing unit 22, which was supplied to all apparatuses in advance before shipment, and sends this encrypted content key Ks(Kc) to the content using unit 23 via the common bus 20. Consequently, in the content provision system 1, the client 12 can protect the content key Kc from an attack by a malicious third party.

It is assumed that the session key is shared in this client 12 before shipment. In this case, the session key may be common to all apparatuses (clients) or may be different for each apparatus (client).

Next, a second embodiment of the present invention will be explained. A client in the second embodiment is a client 50 that is used in the same manner as the client 12 (FIG. 2) in the content provision system 1 shown in FIG. 1, but has a structure different from that of the client 12 as shown in FIG. 22. A nonvolatile memory (EEPROM) 51, which is used for saving seeds of pseudo-random numbers, is connected to the content using unit 23 by a dedicated bus 52. Since the other parts of the structure are the same as those in the structure shown in FIG. 2, the parts are denoted by the identical reference numerals and signs.

This client 50 is different from the client 12 according to the first embodiment in the method of sharing the session key Ks. In the first embodiment, the session key Ks is shared by the authority managing unit 22 and the content using unit 23 at the time of shipment. In the second embodiment, the session key Ks is not shared in advance. The content using unit 23 generates the session key Ks on the basis of a pseudo-random number and shares the same.

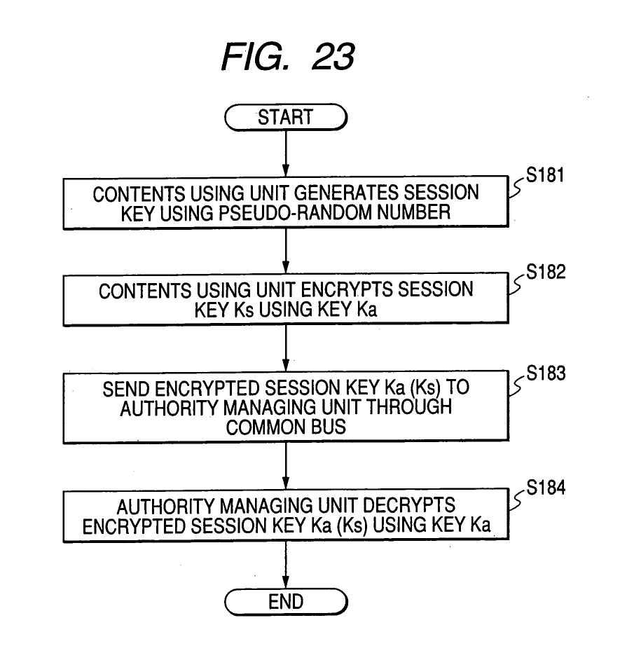

A processing procedure until the content using unit 23 and the authority managing unit 22 share a session key will be explained using the flowchart in FIG. 23. Note that the authority managing unit 22 and the content using unit 23 share a key Ka in advance (before shipment).

First, the content using unit 23 generates a different session key Ks every time on the basis of a pseudo-random number (step S181). The content using unit 23 uses a pseudo-random number for generation of the session key Ks. However, the content using unit 23 saves seeds of the pseudo-random numbers in the EEPROM 51 connected by the dedicated bus 52 such that the same value does not reappear, and rewrites the pseudo-random numbers every time a pseudo-random number is generated such that the pseudo-random numbers cannot be reset. Next, the content using unit 23 encrypts the session key Ks, which is generated by using the pseudo-random number, with the key Ka that the content using unit 23 itself has (step S182). Then, the content using unit 23 sends the encrypted session key Ka(Ks) to the authority managing unit 22 via the common bus 20 (step S183). The authority managing unit 22, having received this encrypted session key Ka(Ks), decrypts the encrypted session key Ka(Ks) with the key Ka, which the authority managing unit 22 itself also has, to obtain the session key Ks (step S184). In this way, the authority managing unit 22 and the content using unit 23 share the session key Ks.

Thereafter, the authority managing unit 22 encrypts the content key Kc, which is extracted from the key information, using the session key Ks (step S174 in FIG. 21) and sends the encrypted content key Ks(Kc) to the content using unit 23 via the common bus 20 (step S175 in FIG. 21).

The content using unit 23 decrypts the encrypted content key Ks(Kc) using the session key Ks (step S176 in FIG. 21) to obtain the content key Kc. Then, the content using unit 23 decrypts the encrypted content Kc (content) using this content key Kc and uses the content (step S177 in FIG. 21).

In this way, the client 50 according to the second embodiment generates a different session key Ks every time in the content using unit 23 from pseudo-random numbers using the EEPROM 51 connected by the dedicated bus 52, encrypts this session key Ks with the key Ka shared in advance, sends the session key Ks to the authority managing unit 22 and shares the session key Ks with the authority managing unit 22. The authority managing unit 22 encrypts the content key Kc, which is extracted from the key information, using the shared session key Ks and sends this encrypted content key Ks(Kc) to the content using unit 23 via the common bus 20. Since a different session key Ks is generated every time, security can be improved.

Note that, in the second embodiment, a pseudo-random number is used as a random number. However, the second embodiment may be modified such that an intrinsic random number is used. In the case of this modification, the content using unit 23 has an intrinsic random number generator in the inside thereof, or the intrinsic random number generator is connected to the outside via the dedicated bus 52.

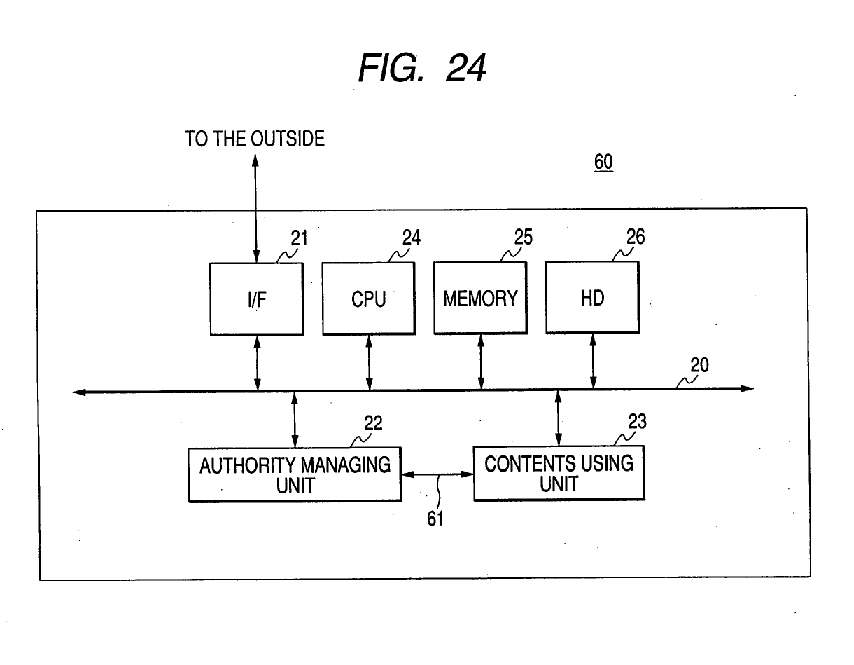

Next, a third embodiment of the present invention will be explained. A client in the third embodiment is a client 60 that is used in the same manner as the client 12 (FIG. 2) in the content provision system 1 shown in FIG. 1, but has a structure different from that of the client 12, as shown in FIG. 24. In the client 60, the authority managing unit 22 and the content using unit 23 are connected by a dedicated bus 61. This dedicated bus 61 is used when the encrypted content key Ks(Kc) is sent and received between the authority managing unit 22 and the content using unit 23. Since the other parts of the structure are the same as those in the structure shown in FIG. 2, the parts are denoted by the identical reference numerals and signs.

This client 60 is different from the client 12 according to the first embodiment in the method of sending the encrypted content key Ks(Kc) encrypted by the shared session key Ks. In the first embodiment, the encrypted content key Ks(Kc) is sent to the content using unit 23 from the authority managing unit 22 through the common bus 20. On the other hand, the client 60 according to the third embodiment sends the encrypted content key Ks(Kc) through the dedicated bus 61 that directly connects the authority managing unit 22 and the content using unit 23. This dedicated bus 61 is a bus that cannot be accessed from the I/F unit 21 directly. Thus, the dedicated bus 61 cannot be accessed from the outside through the I/F unit 21, and an encrypted content key to be distributed can be protected from an attacker.

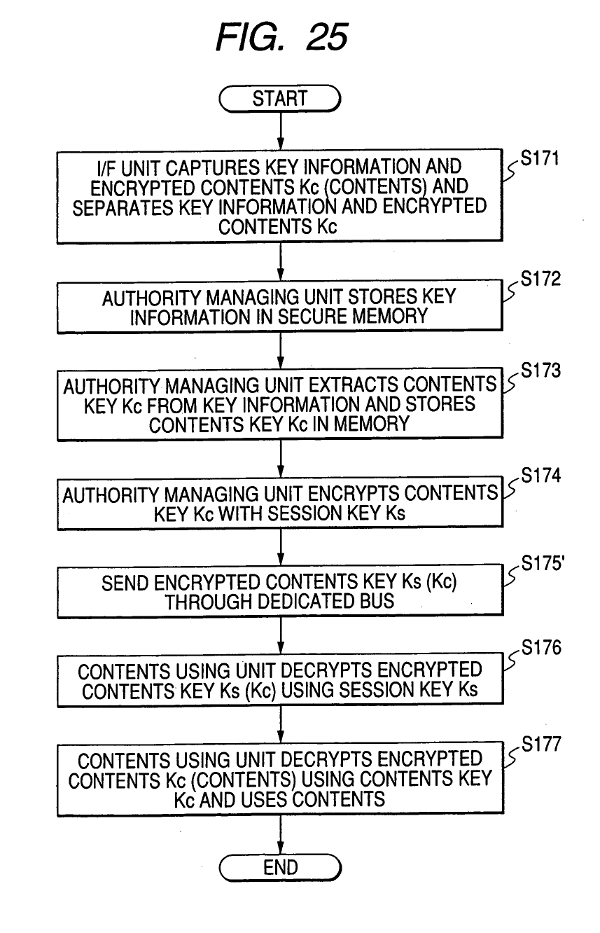

A processing procedure in which the client 60 sends the encrypted content key Ks(Kc) to the content using unit 23 using the dedicated bus 61 and decrypts the content key using the session key Ks in the content using unit 23 will be explained using the flowchart in FIG. 25. This processing procedure is the same as the processing procedure of the first embodiment shown in FIG. 21, except for step S175. In other words, step S175′ is characteristic in the processing procedure in FIG. 25.

After the authority managing unit 22 encrypts the content key Kc, which is stored in the memory 22a, with the session key Ks, which was received in advance at the time of shipment, in step S174, the encrypted content key Ks(Kc) is sent to the content using unit 23 through the dedicated bus 61 in step S175′. Then, the content using unit 23 decrypts the encrypted content key Ks(Kc) using the session key Ks received in advance at the time of shipment (step S176).

In this way, the client 60 according to the third embodiment encrypts the content key Kc, which is extracted from the key information, once using the shared session key Ks in the authority managing unit 22, which was supplied to all apparatuses in advance before shipment, and sends this encrypted content key Ks(Kc) to the content using unit 23 via the dedicated bus 61. This dedicated bus 61 is a bus that cannot be accessed from the I/F unit 21 directly. Thus, the dedicated bus 61 cannot be accessed from the outside through the I/F unit 21, and an encrypted content key to be distributed can be protected from an attacker. Consequently, in the content provision system 1, the client 60 can affirmatively protect the content key Kc from attacks by a malicious third party.

Note that, in the first to the third embodiments, it is mentioned that the encrypted content Kc (content) is decrypted using the content key Kc in the content using unit 23. However, when content is encrypted by the CBC mode in each encryption block using seeds such as an initial vector (IV) and a preceding encryption block, and the content key Kc, the content is decrypted using the seeds such as the IV other than the content key.

A client to which the present invention is applied may be a PDA (Personal Digital Assistant), a cellular phone, a game terminal device, and the like other than a so-called personal computer.

Note that, in this specification, the description of programs to be recorded in a recording medium not only includes processing that is performed in time sequence in accordance with the order of describing the programs, but also includes processing that is not always performed in time sequence but is executed in parallel or individually.

In addition, in this specification, a system represents an entire apparatus that is constituted by plural apparatuses.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A client apparatus that is connectable to a network for receiving content data and key information from a server connected to the network, the client apparatus comprising:
an interface unit operable to capture encrypted content data sent from the server via the network, and key information in which a content key used for generating the encrypted content data is encrypted and stored;
a content data using unit operable to receive the encrypted content data captured by the interface unit, to decrypt the encrypted content data, and to use the content data;
an authority managing unit operable to extract the content key from the key information captured by the interface unit; and
a common bus operable to connect the interface unit, the content data using unit, and the authority managing unit and to transmit at least the encrypted content data and the key information,
wherein the authority managing unit encrypts the content key using a distribution key to obtain a second encrypted content key and distributes the second encrypted content key to the content data using unit, and the content data using unit decrypts the second encrypted content key using the distribution key to obtain a decrypted content key, decrypts the encrypted content data using the decrypted content key, and uses the content data.

2. A client apparatus according to claim 1, wherein the distribution key is stored in the authority managing unit and in the content data using unit in advance, the authority managing unit encrypts the content key using the distribution key stored in the authority managing unit, and the content using unit decrypts the second encrypted content key using the distribution key stored in the content using unit.

3. A client apparatus according to claim 2, wherein the second encrypted content key is distributed to the content key using unit by the common bus.

4. A client apparatus according to claim 1, wherein the authority managing unit comprises a tamper resistant semiconductor element.

5. A client apparatus according to claim 1, wherein a common key is stored in the authority managing unit and in the content using unit in advance, the content data using unit generates the distribution key, encrypts the distribution key using the common key stored in the content data unit, and passes the encrypted distribution key to the authority managing unit through the common bus, and the authority managing unit decrypts the encrypted distribution key using the common key stored in the authority managing unit.

6. A client apparatus according to claim 5, wherein the distribution key is generated using a random number.

7. A client apparatus according to claim 5, wherein the authority managing unit encrypts the content key using the decrypted distribution key to obtain the second encrypted content key, and the second encrypted content key is distributed to the content using unit through the common bus.

8. A client apparatus according to claim 1, further comprising a dedicated bus that directly connects the authority managing unit and the content using unit, wherein the second encrypted content key is distributed from the authority managing unit to the content using unit through the dedicated bus.

9. A content processing method in a client apparatus that is connectable to a network for receiving content data and key information from a server connected to the network, the content processing method comprising:
a receiving step of receiving encrypted content data sent from the server via the network, and key information in which a content key used for generating the encrypted content data is encrypted and stored;
an authority managing step of:
extracting the content key from the key information; and
encrypting the content key using a distribution key to obtain a second encrypted content key; and
a content data using step of:
receiving the second encrypted content key from the authority managing step;
decrypting the second encrypted content key using the distribution key to obtain a decrypted content key;
decrypting the encrypted content data using the decrypted content key; and
using the content data.

10. A content processing method according to claim 9, wherein the authority managing step further includes:
storing the distribution key in advance; and
encrypting the content key using the distribution key stored in advance; and
the content data using step further includes:
storing the distribution key in advance; and
decrypting the second encrypted content key using the distribution key stored in advance.

11. A content processing method according to claim 10, wherein the second encrypted content key is distributed from the authority managing step to the content data using step through a common bus.

12. A content processing method according to claim 9, wherein:
the content data using step further includes:
storing a common key in advance;
generating the distribution key; and
encrypting the distribution key using the common key stored in advance; and
the authority managing step further includes:
storing the common key in advance;
receiving the encrypted distribution key from the content data using step; and
decrypting the encrypted distribution key using the common key stored in advance.

13. A content processing method according to claim 12, wherein the distribution key is generated using a random number.

14. A content processing method according to claim 12, wherein the authority managing step further includes:
encrypting the content key using the decrypted distribution key to obtain the second encrypted content key; and
sending the second encrypted content key to the content data using step.

15. A content processing method according to claim 9, wherein the step of sending the second encrypted content key from the authority managing step to the content data using step is conducted through a dedicated bus.

16. A content provision system, comprising:
a client apparatus; and
a server connected to the client apparatus via a network for providing content to the client apparatus, the client apparatus including:
an interface unit operable to capture encrypted content data sent from the server via the network, and key information in which a content key used for generating the encrypted content data is encrypted and stored;
a content data using unit operable to receive the encrypted content data captured by the interface unit, to decrypt the encrypted content data, and to use the content data;
an authority managing unit operable to extract the content key from the key information captured by the interface unit; and
a common bus operable to connect the interface unit, the content data using unit, and the authority managing unit, and to transmit at least the encrypted content data and the key information,
wherein the authority managing unit encrypts the content key using a distribution key to obtain a second encrypted content key and distributes the second encrypted content key to the content data using unit, and the content data using unit decrypts the second encrypted content key using the distribution key to obtain a decrypted content key, decrypts the encrypted content data using the decrypted content key, and uses the content data.
